(19) United States
(12) Patent Application Publication
(10) Pub. No.: US 2008/0087534 A1
(43) Pub. Date: Apr. 17, 2008

(54) AIR CIRCUIT BREAKER

(75) Inventors: Hong-Ik YANG, Chungcheongbuk-Do (KR); Sang-Chul LEE, Chungcheongbuk-Do (KR); Ki-Hwan KIM, Chungcheongbuk-Do (KR); Kil-Young AHN, Daejeon (KR)

Correspondence Address: GREENBLUM & BERNSTEIN, P.L.C., 1950 ROLAND CLARKE PLACE, RESTON, VA, 20191, US

(73) Assignee: LS INDUSTRIAL SYSTEMS CO., LTD, Seoul (KR)

(21) Appl. No.: 11/870,763

(22) Filed: Oct. 11, 2007

(30) Foreign Application Priority Data
Oct. 17, 2006 (KR) 10-2006-0101065

(51) Int. Cl. H01H 5/00

(52) U.S. Cl. 200/400

(57) ABSTRACT

Disclosed is an air circuit breaker including a switching mechanism formed of a plurality of links so as to compress a closing spring by converting a rotating operation of the rotational shaft and to generate a driving force derived from an elastic restoring force of the closing spring; and a switching shaft mechanically connected to the switching mechanism so as to transfer the driving force generated from the switching mechanism to a movable contact, wherein the switching shaft is provided with a pair of holders installed at both sides from a center of the switching shaft so as to rotatably support the switching shaft at a frame supporting the both sides of the switching mechanism. Accordingly, the operation deviation of the circuit can be minimized by preventing the switching shaft from being deformed when the circuit performs a switching operation, and the lifespan of the air circuit breaker can be increased by reducing abrasion of components.

### CROSS-REFERENCE TO RELATED APPLICATIONS

The present disclosure relates to a subject matter contained in priority Korean Application No. 10-2006-0101065, filed on Oct. 17, 2006, which is herein expressly incorporated by reference in its entirety.

### BACKGROUND

1. Field of the Invention

The present invention relates to an air circuit breaker which is capable of preventing an electric current from being conducted by detecting an over current and a short circuit current.

2. Background of the Invention

Generally, an air circuit breaker is a device for breaking a circuit when occurring an on/off state of a load, overload, short circuit, current leakage, electric shock, and the like.

As shown in FIG. 1, a related air circuit breaker includes a base 110; a switching mechanism 120 compressing a closing spring by converting a rotation force of a rotational shaft 122, which results from an operation of a handle 121, through a mechanical connection of components, and generating a driving force derived from an elastic restoring force of the compressed closing spring; and a switching shaft 130 in which both ends thereof are fixed at the base 110 by a bracket 140 for transferring the driving force generated from the switching mechanism 120 to a movable contact.

As shown in FIGS. 2 and 3, in the related air circuit breaker, after the both ends of the switching shaft 130 are inserted into the bracket 140 and the bracket 140 is fixed at the base 110, a connection shaft 150 is inserted into a ring member 131 installed at a center of the switching shaft 130 and the connection shaft 150 is fixed at the switching mechanism 120, accordingly the switching mechanism 120 and the switching shaft 130 are mechanically connected to each other.

In the related air circuit breaker, the driving force derived from the elastic restoring force of the closing spring, which is generated from the switching mechanism 120, is transferred to the switching shaft 130 through the connection shaft 150, and then transferred to the movable contact, which causes the movable contact to be moved, accordingly switching the circuit.

However, the related air circuit breaker has some problems that the both ends of the switching shaft 130 are fixed at the base 110 by the bracket 140 and the switching mechanism 120 is connected to the switching shaft 130 by the connection shaft 150 which is inserted into the ring member 131 installed at the center of the switching shaft 130, accordingly when the air circuit breaker performs a connecting operation, a great load generated by the closing spring which is rapidly tensioned is converged to the central portion of the switching shaft 130, thereby curving the central portion of the switching shaft 130.

In particular, in case of an air circuit breaker used for a large current, the switching shaft 130 is long, accordingly a distance between portions that are fixed at the base 110 is far, and the switching shaft 130 is remarkably deformed resulting from converging of the load to the central portion of the switching shaft 130, due to the very great load generated from the closing spring. Accordingly, components connected to the switching shaft 130 are abraded and damaged, the air circuit breaker comes to have a great deviation in its operation, a load terminal is damaged occurring when the power applied to the load on switching the air circuit breaker is unbalanced, and a lifespan of the air circuit breaker remarkably decreases.

### SUMMARY

The present inventors recognized the drawbacks of the related art described above. Based upon such recognition, the following features have been conceived.

Therefore, it is an object of the present invention to provide an air circuit breaker which is capable of minimizing a deviation of an operation of a circuit by preventing a switching shaft from being deformed when the circuit performs a switching operation, and of having an increased lifespan by reducing abrasion of components.

The present invention is directed to providing an air circuit breaker comprising: a switching mechanism comprising a plurality of links so as to compress a closing spring by converting a rotating operation of the rotational shaft and to generate a driving force derived from an elastic restoring force of the closing spring; and a switching shaft mechanically connected to the switching mechanism so as to transfer the driving force generated from the switching mechanism to a movable contact, wherein the switching shaft is provided with a pair of holders installed at both sides from a center of the switching shaft so as to rotatably support the switching shaft at a frame supporting the both ends of the switching mechanism.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiment of the invention and together with the description serve to explain the principles of the invention.

In the drawings:

FIG. 1 is a perspective view showing a related air circuit breaker;

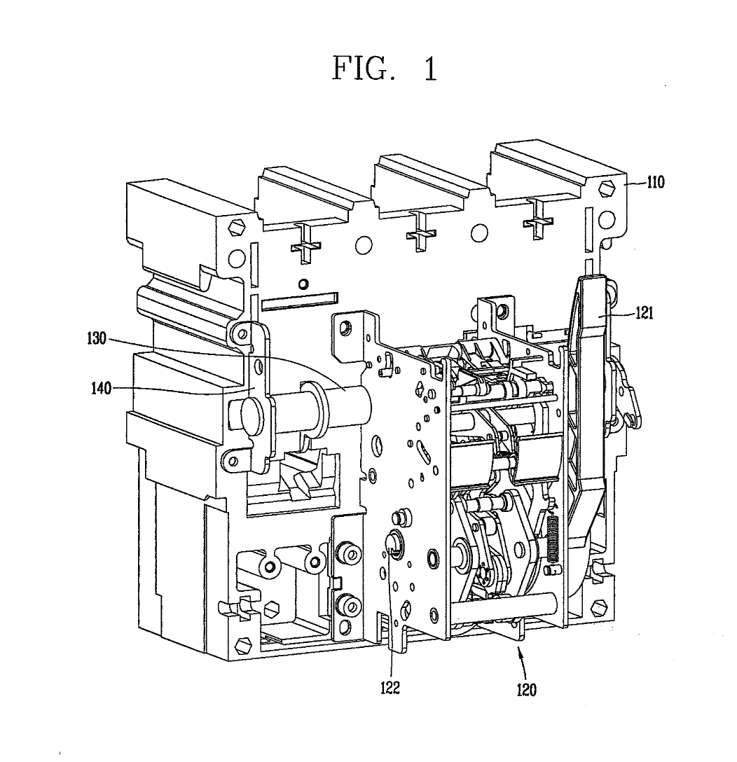

FIG. 2 is an exploded perspective view showing the related air circuit breaker;

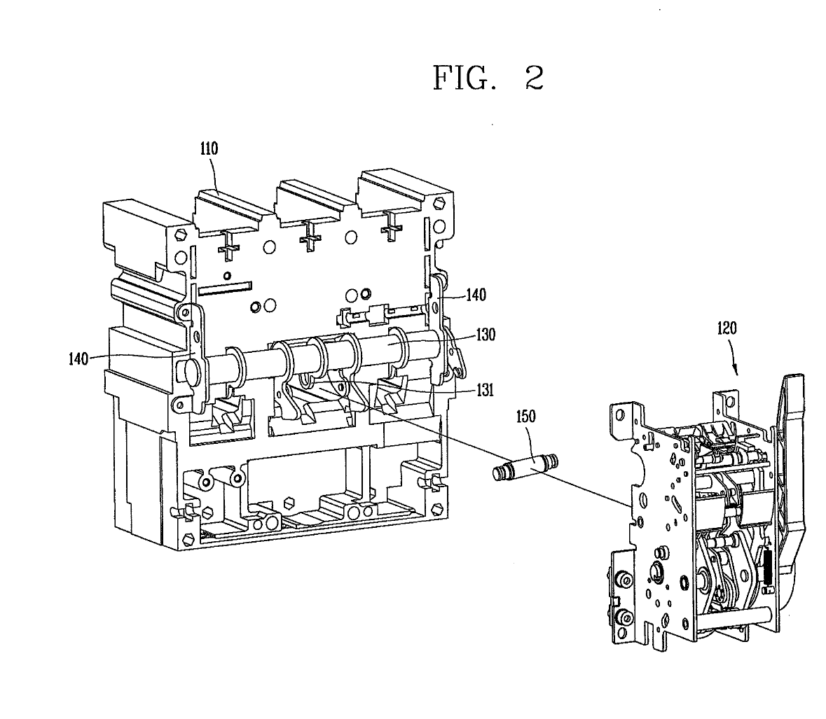

FIG. 3 is a perspective view showing a switching mechanism and a switching shaft of the related air circuit breaker;

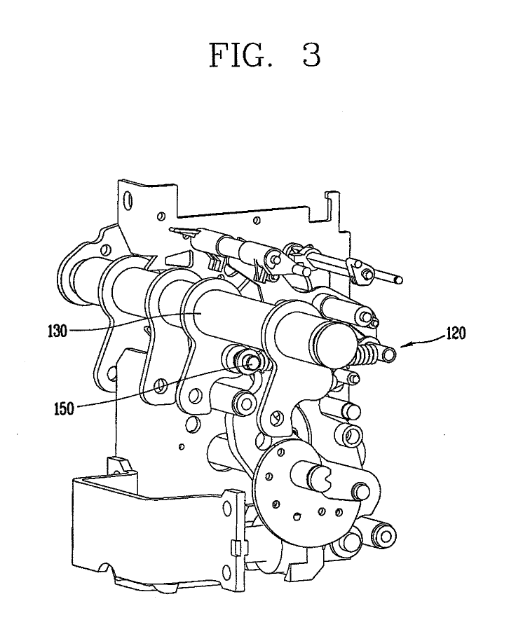

FIG. 4 is a cross-sectional view showing an air circuit breaker in accordance with the present invention;

FIG. 5 is a cross-sectional view showing a state that a closing spring is compressed in the air circuit breaker in accordance with the present invention;

FIG. 6 is a cross-sectional view showing a connected state of the air circuit breaker in accordance with the present invention;

FIG. 7 is an exploded perspective view showing a switching mechanism and a switching shaft of the air circuit breaker in accordance with the present invention;

FIG. 8 is a perspective view showing a state that the switching shaft is fixed at the switching mechanism of the air circuit breaker in accordance with the present invention;

FIG. 9 is a perspective view showing a holder supporting the switching shaft at the switching mechanism of the air circuit breaker in accordance with the present invention; and

FIG. 10 is an exploded perspective view showing the air circuit breaker in accordance with the present invention.

### DETAILED DESCRIPTION

Hereinafter, description will be given in detail of the preferred embodiments of the present invention, examples of which are illustrated in the accompanying drawings. Referring to the drawings, like numerals indicate like elements and the same reference numerals appearing in more than one drawing figures refer to the same elements.

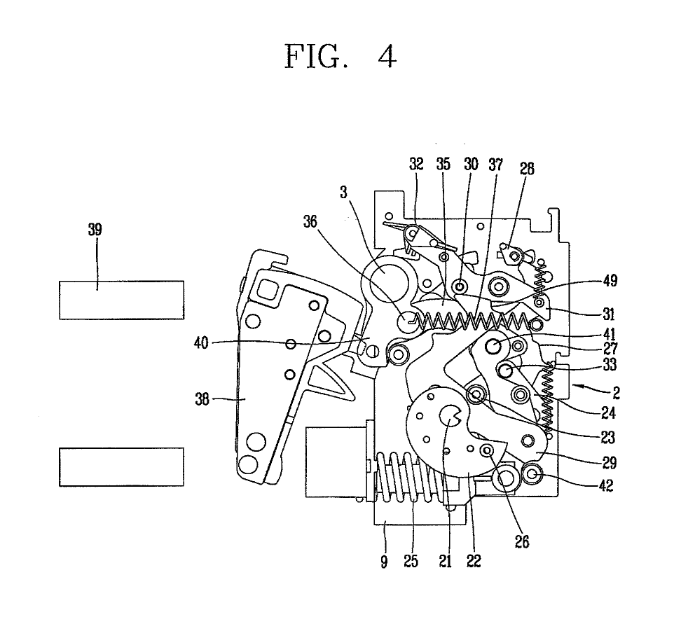

As shown in FIGS. 4 to 6, the air circuit breaker in accordance with the present invention includes: a switching mechanism 2 generating a driving force; a switching shaft 3 rotatably installed at a rear side of the switching mechanism 2 so as to transfer the driving force generated from the switching mechanism 2 to a movable contact.

The switching mechanism 2 includes: a cam 22 connected to a rotational shaft 21 and rotated manually or automatically; a driving lever 24 rotatably installed at a frame 9 supporting both sides of the switching mechanism 2, and provided with a lever roller 23 so as to be rotated resulting from the lever roller 23 rotating along a curved surface of the cam 22, when the cam 22 is rotated; a closing spring 25 having one end connected to a lower end portion of the driving lever 24 and the other end supported at the frame 9 and compressed by a rotation of the driving lever 24 according to the rotation of the cam 22 so as to store an elastic energy; a first latch 27 extending longitudinally to be elastically installed at the frame 9, and having a particular recess at its lower side surface such that it is restrained when a pin 26 disposed at the cam 22 is locked by the recess; a closing switch 28 disposed at an upper side of the first latch 27 to release the restraint of the first latch 27; a first link 29 extending longitudinally, and having a lower end portion of the first link 29 connected to an upper end portion of the driving lever 24 so as to be rotated by the rotation of the driving lever 24 and a particular recess 49 at its upper side; a second latch 31 disposed at the upper side of the first link 29, and having a latch roller 30 in contact with an upper surface of the first link 29 to be rotated by the rotation of the first link 29, wherein the second latch 31 is restrained when the latch roller 30 is locked by the recess 49 of the first link 29; an opening switch 32 disposed at the upper side of the second latch 31 to release the restraint of the second latch 31; a stopper 42 disposed at a lower side of the frame 9 to prevent the rotation of the first link 29 over a certain displacement when the air circuit breaker performs a breakage (opening) operation; a second link 34 having a lower end portion connected to the driving lever 24 together with the first link 29, and disposed to come in contact with a pin 33 formed at the driving lever 24; a third link 35 connected to an upper end of the second link 34 by a connection pin 41 to be rotated according to a displacement of the second link 34; a connection shaft 36 for allowing the third link 35 to be connected to the switching shaft 3; an opening spring 37 having one end fixed to the connection shaft 36 and the other end supported at the frame 9; and a leg 40 fixed to the switching shaft 3 to move the movable contact 38 toward a terminal 39 when the switching shaft 3 is rotated.

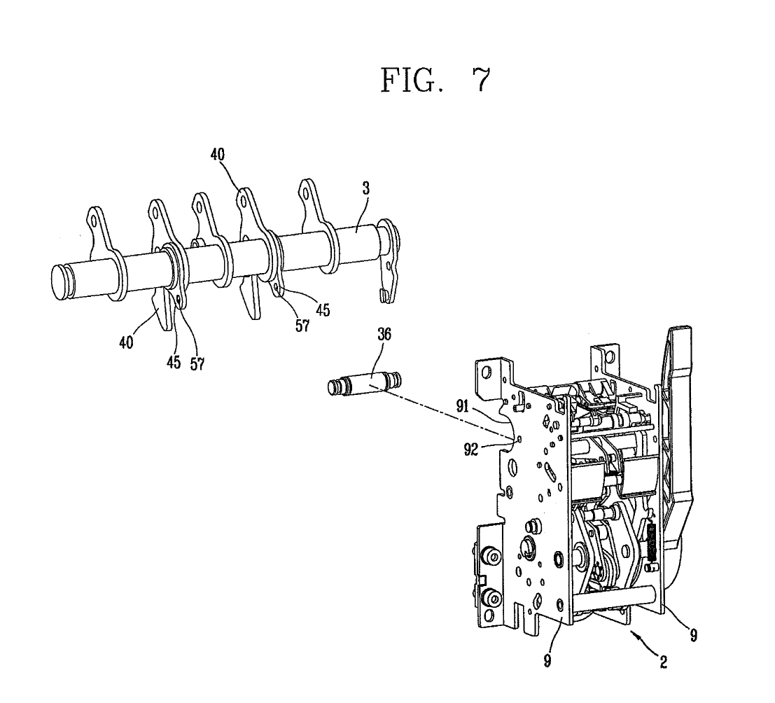

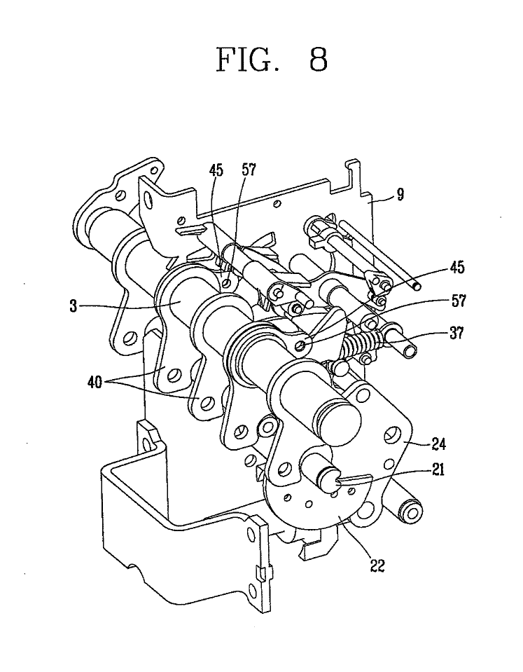

As shown in FIGS. 7 and 8, the switching shaft 3 is provided with a pair of holders 45 adhered to one side surface of the leg 40, wherein the holders 45 are disposed at both sides from the center of the switching shaft 3.

An insertion recess 91 for rotatably inserting the switching shaft 3 thereinto is formed at the frame 9, and a fixing hole 92 for fixing the holder 45 at the frame 9 is formed at one side of the insertion recess 91.

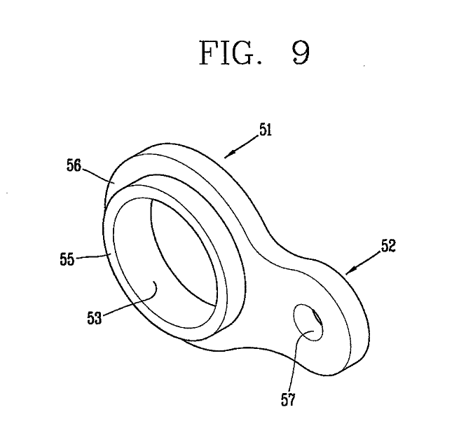

As shown in FIG. 9, the holder 45 includes: a support portion 51 having a through hole 53 into which the switching shaft 3 is inserted so as to support the switching shaft 3 at the insertion recess 91 of the frame 9; and a fixing portion 52 extended to one side from the supporting portion 51 to be fixed at the frame 9.

The support portion 51 of the holder 45 includes an insertion portion 55 inserted into the insertion recess 91 so that an outer circumferential surface thereof can be adhered to an inner circumferential surface of the insertion recess 91; and a stopping portion 56 formed at an outer circumference of the insertion portion 55 to be contacted to the outer side surface of the frame 9.

A coupling hole 57 corresponding to the fixing hole 92 of the frame 9 is formed at the fixing portion 52 of the holder 45, accordingly, the holder 45 is fixed at the frame 9 through coupling means such as a screw, a rivet, or the like.

Accordingly, the insertion portion 55 is inserted into the insertion recess 91 of the frame 9 and the stopping portion 56 is contacted to the outer side surface of the frame 9 so as to support the insertion portion 55, under a state that the switching shaft 3 is inserted into the through hole 53 of the support portion 51 of the holder 45. Thereby, the holder 45 supports the switching shaft 3 at the insertion recess 91 of the frame 9 and serves as a bearing preventing the switching shaft 3 from having a friction with the frame 9, when the switching shaft 3 is rotated.

Meanwhile, preferably, the support portion 51 and the fixing portion 52 of the holder 45 are integrally formed as one member so as to be easy to be processed and assembled and disassembled to the frame 9.

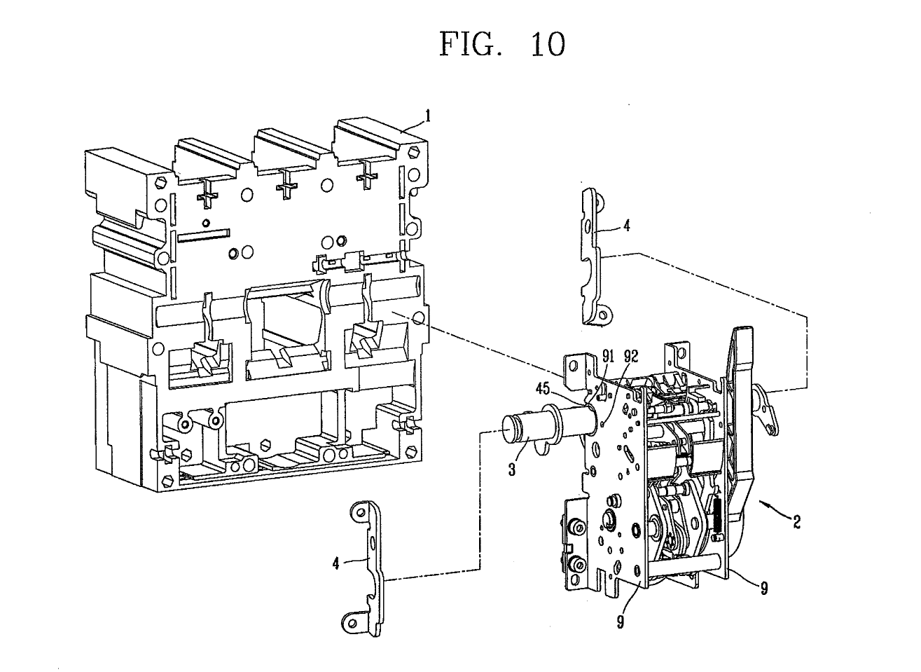

In the meantime, as shown in FIG. 10, both ends of the switching shaft 3 are fixed at a base 1 by using a bracket 4.

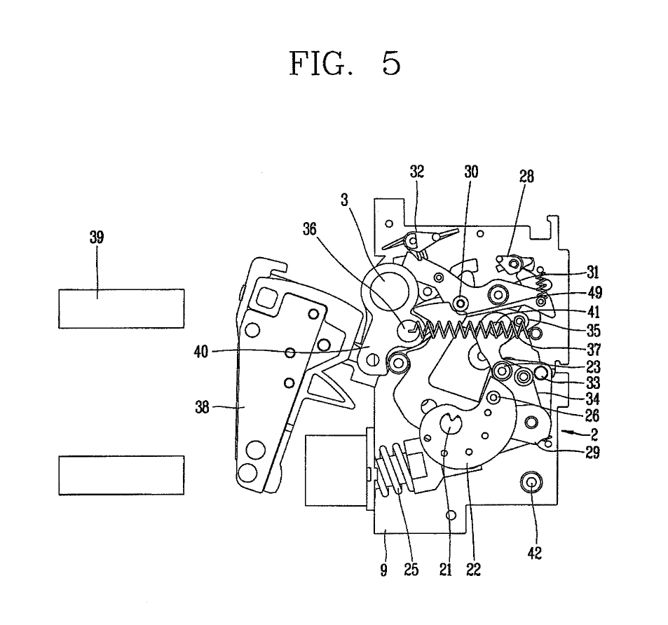

In such air circuit breaker in accordance with the present invention, as shown in FIG. 4, under an opened state that the movable contact 38 is separated from the terminal 39, the cam 22 is rotated when the rotational shaft 21 is rotated manually or automatically, accordingly, as shown in FIG. 5, the driving lever 24 is rotated, thereby compressing the closing spring 25.

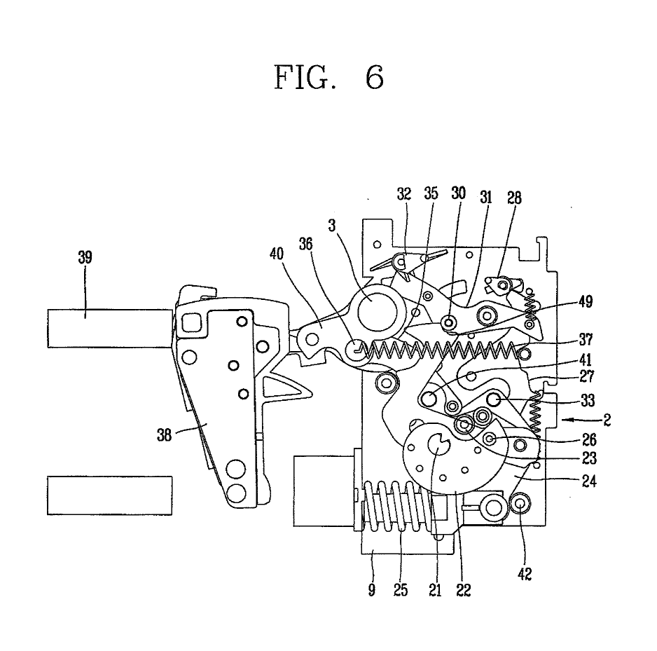

And, the elastic energy of the closing spring 25 is transferred through each link element of the switching mechanism 2, and then the switching shaft 3 connected to the third link 35 is rotated, as shown in FIG. 6, accordingly the movable contact 38 comes in contact with the terminal 39, thereby enabling the current to be conducted.

That is, in the process of contacting the movable contact 38 with the terminal 39 to be conducted, the elastic energy of the closing spring 25 is transferred to the third link 35, and then the third link 35 moves to the left side. Accordingly, the switching shaft 3 connected to the third link 35 through the connection shaft 36 and the holder 45 comes to be rotated, and then the movable contact 38 is moved by the leg 40 installed at the switching shaft 3 to be connected to the terminal 39.

Also, when the circuit is broken, the movable contact 38 is spaced from the terminal 39 by the elastic force of the tensioned opening spring 37, as shown in FIG. 4, accordingly being returned to its original state.

Here, the switching shaft 3 is supported at both sides of the frame 9 through the holder 45, accordingly the load transferred to the switching shaft 3 is not concentrated to the central portion of the switching shaft 3, but distributed to both sides of the switching shaft 3, thereby preventing the central portion of the switching shaft 3 from being curved, for example.

As aforementioned, in the air circuit breaker in accordance with the present invention, the switching shaft 3 transferring the driving force generated from the switching mechanism 2 is rotatably supported at the frame 9 supporting both sides of the switching mechanism 2 by using the pair of holders 45, accordingly the load applied to the central portion of the switching shaft 3 is distributed to both sides of the switching shaft 3. Accordingly, the switching shaft 3 can be prevented from being deformed when the circuit performs the switching operation, thereby being capable of minimizing the operation deviation of the circuit. Further, the air circuit breaker can have an increased lifespan by reducing abrasion the components.

The foregoing embodiments and advantages are merely exemplary and are not to be construed as limiting the present invention. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present inventive features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. An air circuit breaker comprising:
a switching mechanism comprising a plurality of links so as to compress a closing spring by converting a rotating operation of the rotational shaft and to generate a driving force derived from an elastic restoring force of the closing spring; and
a switching shaft mechanically connected to the switching mechanism so as to transfer the driving force generated from the switching mechanism to a movable contact,
wherein the switching shaft is provided with a pair of holders installed at both sides from a center of the switching shaft so as to rotatably support the switching shaft at a frame supporting the both ends of the switching mechanism.

2. The air circuit breaker of claim 1, wherein the holder comprises a support portion inserted into the switching shaft; and a fixing portion extended from one side of the supporting portion to be fixed at the frame.

3. The air circuit breaker of claim 2, wherein the insertion recess into which the switching shaft is inserted is formed at the frame, and the support portion of the holder comprises an insertion portion inserted into the insertion recess of the frame and a stopping portion formed at an outer circumference of the insertion portion to be contacted with an outer side surface of the frame.

4. The air circuit breaker of claim 2, wherein the support and fixing portions of the holder are integrally formed.

5. The air circuit breaker of claim 3, wherein a fixing hole is formed at one side of the insertion recess of the frame, and a coupling hole corresponding to the fixing hole of the frame is formed at the fixing portion of the holder.

6. The air circuit breaker of claim 3, wherein the support and fixing portions of the holder are integrally formed.
